(19) United States
(12) Patent Application Publication
(10) Pub. No.: US 2026/0189576 A1
(43) Pub. Date: Jul. 2, 2026

(54) DISTRIBUTED EDGE-NATIVE SYSTEM AND METHOD FOR REAL-TIME DETECTION AND PREVENTION OF MALICIOUS DIGITAL ACTIVITY

(71) Applicant: Ravi THEJA KAMBHAMPATI, Maple Valley, WA (US)

(72) Inventor: Ravi THEJA KAMBHAMPATI, Maple Valley, WA (US)

(21) Appl. No.: 19/541,745

(22) Filed: Feb. 17, 2026

(51) Int. Cl. H04L 9/40

(52) U.S. Cl. CPC H04L 63/1416; H04L 63/20

(57) ABSTRACT

A distributed edge-native system and method for real-time detection and prevention of malicious digital activity combines privacy-preserving behavioral analytics with graph-based risk intelligence. Client-side instrumentation observes user interactions and transforms behavioral data using irreversible techniques including hashing, dimensional compression, and tokenization before transmission. Distributed edge enforcement nodes intercept application-layer requests, compute preliminary risk assessments using locally cached models, and execute inline traffic control operations including blocking, throttling, and challenge issuance. A streaming layer ingests telemetry and enriches events with network attributes. An identity graph engine constructs evolving graph structures linking users, devices, sessions, and network identifiers, inferring relationships through behavioral similarity and temporal correlation. A risk intelligence platform computes risk scores from graph-derived features, trains adaptive detection models, and distributes updated policies to edge nodes, enabling autonomous threat mitigation with minimal latency while preserving user privacy.

### FIELD OF THE INVENTION

The present invention relates to systems and methods for detecting and preventing malicious or fraudulent digital activity in distributed computing environments, and more particularly to an edge-native security architecture for identifying and mitigating threats including account takeover, credential abuse, automated bot attacks, payment fraud, and coordinated malicious campaigns.

### BACKGROUND OF THE INVENTION

With the exponential growth of digital services and online transactions, malicious actors have increasingly exploited vulnerabilities in web applications, mobile platforms, and API-driven systems to perpetrate fraud, theft, and abuse. Traditional security approaches face several critical limitations. First, centralized security architectures introduce latency bottlenecks, as traffic must traverse to distant data centers for risk assessment before enforcement decisions can be executed. This latency is problematic for real-time applications where millisecond delays degrade user experience. Second, conventional systems typically collect and transmit raw user behavioral data to central servers, thereby creating significant privacy risks and regulatory compliance challenges under frameworks such as GDPR, CCPA, and similar data protection regulations. Third, existing fraud detection systems typically analyze individual requests in isolation, thus failing to detect sophisticated coordinated attacks where multiple compromised accounts, devices, or network identities act in concert to evade detection. Fourth, traditional rule-based systems lack adaptive learning capabilities and cannot effectively respond to evolving attack patterns without manual intervention. Fifth, many security solutions require integration deep within application logic, creating deployment complexity and vendor lock-in. These deficiencies result in ineffective threat detection, increased false positives, degraded user experience through excessive friction, and inadequate protection against modern attack vectors including credential stuffing, account takeover campaigns, distributed bot networks, payment fraud rings, and automated scraping operations.

Therefore, there exists a need for a distributed security architecture that can perform real-time risk assessment and enforcement at network edges with minimal latency, preserve user privacy through client-side data transformation, detect coordinated malicious activity through relationship analysis, adapt continuously to emerging threats through machine learning, and operate independently of centralized infrastructure to ensure resilience and scalability.

### BRIEF SUMMARY OF THE INVENTION

It is an object of the present invention to provide a distributed security system that performs real-time risk assessment and threat mitigation at network edge locations with sub-millisecond decision latency.

It is another object to preserve end-user privacy by performing behavioral data transformations on client devices using irreversible cryptographic and statistical techniques, thereby preventing transmission of personally identifiable information or raw biometric data.

It is a further object to detect coordinated malicious activity across multiple entities by constructing and analyzing dynamic graph structures that model relationships between users, devices, sessions, credentials, and network identifiers based on behavioral similarity, temporal correlation, and communication patterns.

It is yet another object to provide adaptive threat detection through continuous machine learning model training using labeled feedback from enforcement actions and user responses.

It is still another object to enable autonomous edge enforcement that operates independently of centralized decision-making infrastructure, thereby ensuring system resilience and scalability.

It is an additional object to provide inline traffic control at application protocol layers for granular enforcement actions including selective blocking, adaptive throttling, cryptographic challenges, authentication escalation, and session termination.

It is a further object to achieve these capabilities through a modular architecture comprising client-side instrumentation, distributed edge enforcement nodes, streaming event processing, identity graph analysis, and centralized risk intelligence, wherein each component operates cohesively while maintaining operational independence.

These and other objects are achieved through the system and method embodiments described herein.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating principles of the invention.

FIG. 1 is a sequence diagram illustrating the operational flow of a distributed edge-native risk detection system according to an embodiment of the present invention.

FIG. 2 is an architectural diagram depicting a complete distributed edge-first security and risk architecture according to an embodiment of the present invention.

### DETAILED DESCRIPTION OF THE INVENTION

The present invention will now be described more fully hereinafter with reference to the accompanying drawings, in which preferred embodiments of the invention are shown. The described embodiments are illustrative and exemplary rather than exhaustive or limiting. The invention is not limited to the precise embodiments described. Many variations, modifications, substitutions, and equivalents will be apparent to persons skilled in the art upon reading this disclosure. Features described in connection with one embodiment may be combined with features from other embodiments to create additional embodiments not explicitly described. The absence of explicit description of a particular combination of features does not indicate that such combination is excluded from the scope of the invention.

As used herein, the terms “module,” “component,” “engine,” “subsystem,” and “platform” refer to computational units that may be implemented in hardware, software, firmware, or combinations thereof, and may comprise one or more processors, memory, storage, communication interfaces, and executable instructions. The terms “comprises,” “comprising,” “includes,” and “including” are inclusive and open-ended, not excluding additional elements or steps. The singular forms “a,” “an,” and “the” include plural referents unless the context clearly dictates otherwise.

“Behavioral Telemetry” refers to raw observational data captured by the client-side instrumentation module reflecting user interactions with application interfaces, including but not limited to keystroke timing sequences, mouse trajectory coordinates, touch pressure values, scroll velocity measurements, navigation click sequences, and application state transitions. The term is used interchangeably with “behavioral signals,” “interaction data,” and “client-side telemetry.”

“Behavioral SDK” refers to the software development kit embedded within client applications responsible for capturing behavioral telemetry. The Behavioral SDK may also be referred to as “client-side instrumentation module,” “instrumentation library,” “telemetry agent,” “behavioral agent,” or “client SDK.”

“Privacy-Preserving Feature Representation” refers to a transformed numerical vector derived from behavioral telemetry through irreversible transformations that prevent recovery of original data. This term is used interchangeably with “privacy-preserving feature vector,” “transformed feature vector,” “anonymized feature vector,” and “encoded behavioral representation.”

“Edge Enforcement Node” refers to a computing resource positioned at or near a network ingress point configured to intercept, evaluate, and act upon application-layer requests. Edge enforcement nodes may also be referred to as “edge nodes,” “edge points of presence,” “edge PoPs,” “network edge servers,” “CDN nodes,” “API gateway nodes,” or “reverse proxy nodes.”

“Risk Score” refers to a numerical value, typically normalized to a range of 0.0 to 1.0 or 0 to 100, representing the estimated probability or severity of malicious activity associated with a given request or entity. The term is used interchangeably with “risk value,” “threat score,” “fraud score,” “malicious activity probability,” and “anomaly score.”

“Identity Graph” refers to a graph data structure comprising entity nodes and weighted relational edges that model relationships between users, devices, sessions, credentials, and network identifiers observed across multiple requests and time periods. The term is used interchangeably with “entity relationship graph,” “fraud graph,” “behavioral graph,” “threat graph,” and “risk graph.”

“Streaming layer” refers to the distributed infrastructure responsible for ingesting, normalizing, enriching, and delivering telemetry events from edge nodes and client devices to downstream analytical services. The term is used interchangeably with “streaming event fabric,” “event streaming platform,” “streaming infrastructure,” “event pipeline,” and “event bus.”

“Inline Enforcement” refers to the execution of traffic control operations directly within the request processing path at edge nodes, without requiring redirection to separate enforcement infrastructure. The term is used interchangeably with “inline traffic control,” “edge enforcement,” “request-time enforcement,” and “real-time enforcement.”

“Model Training Subsystem” refers to the components responsible for periodically retraining machine learning detection models using accumulated labeled data. The term is used interchangeably with “model training pipeline,” “ML training system,” “retraining pipeline,” and “adaptive learning subsystem.”

“Explainability Framework” refers to the components that generate human-interpretable rationales for risk decisions, identifying which features contributed most significantly to a given risk score. The term is used interchangeably with “explanation engine,” “interpretability module,” “decision rationale generator,” and “audit framework.”

“Session” refers to a logical grouping of temporally proximate requests originating from a common user, device, or application context, bounded by inactivity gaps exceeding a configured timeout threshold. The term is used interchangeably with “user session,” “interaction session,” “browsing session,” and “application session.”

“Enrichment” refers to the process of augmenting raw telemetry events with derived contextual attributes including geographic location, autonomous system information, protocol fingerprints, and threat intelligence indicators. The term is used interchangeably with “event enrichment,” “telemetry enrichment,” “context augmentation,” and “metadata augmentation.”

“Feature Store” refers to a low-latency data store containing precomputed feature values indexed by entity identifiers, enabling rapid feature retrieval during real-time model inference. The term is used interchangeably with “online feature store,” “feature cache,” “feature database,” and “feature repository.”

“Differential Privacy” refers to a mathematical framework for quantifying and limiting privacy risk, wherein calibrated statistical noise is added to data or computations to provide formal privacy guarantees expressed through privacy budget parameters epsilon and delta.

“TLS Fingerprint” or “JA3 Fingerprint” refers to a compact identifier derived from the parameters of a Transport Layer Security handshake, including cipher suite preferences, supported protocol versions, and extension values, that uniquely characterizes the client software implementation.

“Autonomous System Number” or “ASN” refers to a globally unique identifier assigned to a collection of IP routing prefixes under the control of a single administrative entity, used to identify Internet service providers, hosting facilities, cloud platforms, and enterprise networks.

“Velocity Metric” refers to a derived feature measuring the rate of occurrence of a specific event type associated with a given entity identifier within a defined time window, used to detect abnormally high frequency patterns indicative of automated activity.

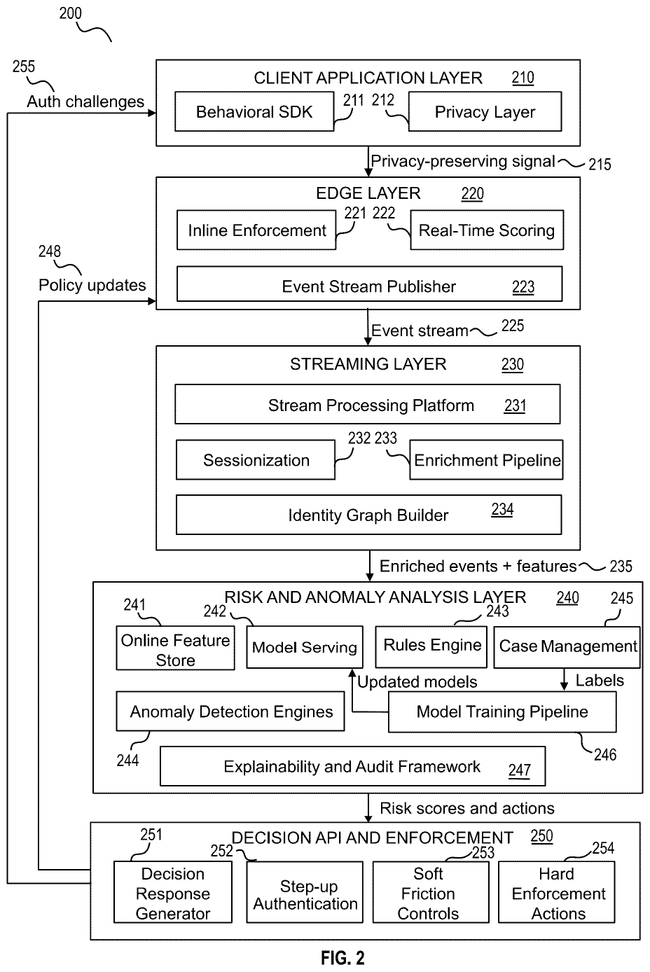

Referring now to FIG. 2, a distributed edge-first security and risk architecture 200 is illustrated according to an embodiment of the present invention. The system 200 comprises multiple hierarchical layers that operate cohesively to detect and prevent malicious digital activity while preserving user privacy and maintaining low-latency response times. The malicious digital activity detected and prevented by the system 200 includes, but is not limited to: automated bot attacks such as web scraping bots, inventory hoarding bots, scalping bots, click fraud bots, and comment spam bots; credential-based attacks including credential stuffing using stolen username-password pairs from data breaches, brute force attacks systematically trying password combinations, password spraying across multiple accounts, and dictionary attacks using common password lists; account takeover attempts through session hijacking, cookie theft, SIM swapping, email account compromise, and social engineering; payment and transaction fraud including credit card testing, card-not-present fraud, friendly fraud with false chargeback claims, refund fraud, triangulation fraud, and account enumeration; identity fraud comprising synthetic identity fraud using combinations of real and fabricated information, identity theft, application fraud with false information on loan or credit applications, and new account fraud; application layer attacks such as API abuse with excessive or unauthorized calls, SQL injection, cross-site scripting, directory traversal, and remote code execution attempts; denial of service attacks including application-layer distributed denial of service, slowloris attacks, HTTP floods, and XML or JSON bomb payloads; fake account creation through mass automated registration, email verification bypass, CAPTCHA farms, and throwaway accounts; content manipulation and abuse including review manipulation, vote manipulation, social media engagement fraud, and astroturfing; data exfiltration attempts involving unauthorized data access, insider threats, and API data harvesting; promotional and loyalty abuse such as promo code farming, referral fraud, bonus abuse, and coupon stacking; account abuse patterns including multi-accounting to circumvent limits, unauthorized account sharing, geo-blocking evasion through VPNs or proxies, and age verification bypass; marketplace and platform abuse comprising seller fraud, bid shilling, price manipulation, and wash trading; gaming and gambling fraud including chip dumping, gnoming with multiple accounts, bonus hunting, and collusion; and mobile-specific attacks such as app cloning, emulator detection evasion, device farm attacks, and jailbreak or root detection bypass. The architecture 200 is organized into distinct functional layers including a client application layer 210, an edge layer 220, a streaming layer 230, a risk and anomaly analysis layer 240 (also referred to herein as the risk intelligence platform), and a decision API and enforcement layer 250. Each layer provides specific capabilities while maintaining operational independence to ensure system resilience and scalability.

The client application layer 210 comprises a behavioral SDK 211 and privacy layer 212 that execute on user devices. The behavioral SDK 211 is configured to observe user interaction events including input timing patterns such as keystroke dynamics and inter-key latencies, gesture dynamics including mouse movement trajectories and touch pressure variations, navigation sequences comprising page transitions and element interaction orders, application state transitions, device integrity indicators such as jailbreak detection and debugger presence, and execution environment attributes including browser fingerprints and operating system characteristics. The behavioral SDK 211 aggregates these observations and performs temporal analysis to generate behavioral feature data that characterizes user interaction patterns. The privacy layer 212 transforms the behavioral feature data into privacy-preserving feature representations using irreversible transformation techniques, wherein the irreversible transformations include cryptographic hashing functions that produce fixed-length digests from variable-length inputs, dimensional compression algorithms such as principal component analysis or autoencoders that reduce feature dimensionality while preserving discriminative information, tokenization methods that replace sensitive values with non-reversible identifiers, statistical noise injection including differential privacy mechanisms that add calibrated random noise, and cryptographic encoding schemes such as homomorphic encryption or secure multi-party computation primitives.

In some embodiments, the privacy layer 212 suppresses transmission of raw interaction data and personally identifiable information, thereby ensuring that only transformed representations traverse network boundaries. The privacy-preserving feature representations are transmitted from the client application layer 210 over secured communication channels 215 using transport layer security or equivalent cryptographic protocols to the edge layer 220.

The edge layer 220 comprises a plurality of edge enforcement nodes distributed across network ingress locations such as content delivery network points of presence, API gateways, and reverse proxy servers. Each edge enforcement node includes an policy execution component 221 configured to receive application-layer requests prior to routing to application services.

In one aspect of the present invention, the policy execution component 221 operates at OSI layer 7 to inspect HTTP/HTTPS requests, WebSocket connections, gRPC calls, and other application protocols. Each edge enforcement node further includes a real-time scoring engine 222 configured to compute a preliminary risk value using locally stored machine learning (ML) detection models and policy data. The detection models may comprise ML classifiers such as gradient boosted decision trees, neural networks, or ensemble methods trained to predict malicious activity probability from input features. The policy data specifies risk thresholds and corresponding enforcement actions. The real-time scoring engine 222 accesses an edge cache containing synchronized copies of current models and policies, thereby enabling autonomous decision-making without dependence on centralized infrastructure. Each edge enforcement node additionally includes the policy execution component 221 configured to selectively perform inline traffic control operations, wherein the traffic control includes request blocking wherein HTTP responses with denial status codes are returned to clients, connection throttling wherein request processing is deliberately delayed or rate-limited, protocol alteration such as HTTP to HTTPS redirection, response modification including content sanitization or warning injection, cryptographic challenge issuance such as CAPTCHA presentation or proof-of-work requirements, authentication escalation wherein additional credential verification is demanded, and session termination wherein user sessions are invalidated and clients are forced to re-authenticate.

In some aspects, the policy execution component 221 selects appropriate enforcement actions based on computed risk scores from the real-time scoring engine 222 and policy specifications. Each edge enforcement node includes an event stream publisher 223 configured to transmit request metadata and enforcement outcomes via event stream connection 225 to the streaming layer 230 for further analysis. The transmitted telemetry includes feature vectors, risk scores, enforcement actions taken, client responses to challenges, and temporal information. Importantly, the plurality of edge enforcement nodes execute enforcement actions independently of centralized traffic routing infrastructure, meaning that traffic interception, risk assessment, and enforcement occur locally at each edge location without requiring communication with central decision systems for each request, thereby minimizing latency and ensuring continued operation during network partitions.

The streaming layer 230 comprises a stream processing platform 231, sessionization component 232, enrichment pipeline 233, and identity graph builder 234. The stream processing platform 231 comprises distributed processing resources configured to handle high-volume telemetry ingestion and real-time event processing. The stream processing platform 231 ingests telemetry originating from both the client-side instrumentation module 211 and the plurality of edge enforcement nodes 220 via the event stream publisher 223. In some aspects, ingestion utilizes message queuing systems such as Apache Kafka, Amazon Kinesis, or similar distributed streaming platforms that provide fault tolerance, horizontal scalability, and ordered message delivery guarantees. The stream processing platform 231 normalizes event formats into a unified schema, transforming heterogeneous input data structures into standardized representations with consistent field names, data types, and semantic meanings. In one aspect, the enrichment pipeline 233 enriches ingested telemetry with derived network attributes. Enrichment includes geographic region determination through IP geolocation databases, autonomous system identifier lookup via Border Gateway Protocol routing tables, protocol fingerprint extraction from TLS handshake parameters and HTTP header combinations, and session identifier assignment for correlation of related requests. The stream processing platform 231 provides ordered event delivery to subscribing analytical services, maintaining causal ordering guarantees and enabling stateful stream processing applications.

In one aspect, the sessionization component 232 of the streaming layer 230 additionally performs sessionization, grouping related events into logical session boundaries based on temporal proximity, common identifiers, and behavioral continuity. The risk and anomaly analysis layer 240 comprises an identity graph builder 234 (which may also be part of streaming layer 230 as shown in FIG. 2), online feature store 241, model serving 242, rules engine 243, anomaly detection engines 244, case management 245, model training subsystem 246, and explainability and audit framework 247. The identity graph builder 234 constructs graph data structures comprising entity nodes representing users, devices, sessions, credentials, and network identifiers such as IP addresses and autonomous systems. In one aspect, the identity graph builder 234 infers relational edges between entity nodes based on multiple criteria. Further, behavioral similarity is computed using distance metrics applied to feature vectors, with nodes connected when similarity exceeds threshold values. Temporal correlation identifies entities appearing together within time windows, thereby suggesting coordinated activity. Communication proximity analyzes network traffic patterns to discover entities communicating through common intermediaries or exhibiting synchronized behaviors.

In some embodiments, the threshold values governing behavioral similarity-based edge creation in the identity graph are configurable parameters specified through administrative interfaces or automated tuning procedures. For example, a cosine similarity threshold of 0.85 may be configured to connect device nodes exhibiting highly similar behavioral feature vectors, while a lower threshold of 0.65 may be applied for connecting session nodes where partial behavioral overlap is sufficient to infer relationship. These threshold parameters may be adjusted dynamically based on observed false positive rates, attack volumes, or business risk tolerance requirements, enabling operators to balance detection sensitivity against false positive rates without modifying underlying graph construction logic.

In some aspects, the identity graph builder 234 dynamically updates relationship weights using time-based decay functions, thereby reducing edge weights for relationships not recently reinforced, and thereby allowing the graph to adapt to changing attack patterns and ensuring that stale relationships do not unduly influence risk assessments. The identity graph builder 234 detects anomalous multi-entity structures indicative of coordinated malicious activity, such as densely connected subgraphs representing bot networks, star patterns suggesting credential stuffing from a single source, or chain structures indicating account takeover progression. The stream processing platform 231 executes continuous queries on event streams, computing aggregations, joins, and windowed analytics. The anomaly detection engines 244 apply statistical methods, unsupervised learning algorithms such as isolation forests or one-class support vector machines, and supervised models to identify deviations from expected patterns.

In some aspects, the risk and anomaly analysis layer 240 comprises multiple interconnected components that provide centralized model training, policy generation, and intelligence distribution. The model serving component 242 computes risk scores using features derived from the identity graph builder 234 and retrieved from the online feature store 241, combining graph-based features such as node centrality metrics, edge density measures, and community detection results with behavioral features and historical patterns.

The real-time scoring engine additionally computes path-based graph features through shortest path analysis between entity nodes, determining the minimum number of relationship hops separating a requesting entity from previously identified malicious nodes flagged through confirmed fraud investigations, chargeback events, or regulatory enforcement actions. Entities directly connected to known malicious nodes receive elevated risk contributions, while entities separated by two or three hops receive proportionally reduced but non-zero contributions reflecting indirect association risk. Path length features are computed using breadth-first search algorithms executed against the identity graph, with results cached per entity node and refreshed at configurable intervals of 5 to 60 minutes to balance computational overhead against feature freshness. In some embodiments, weighted path analysis accounts for edge weight decay values along traversed paths, computing cumulative path risk scores that reflect both topological proximity and relationship recency.

The risk scores represent probability estimates or severity assessments of malicious activity. The rules engine 243 derives enforcement directives based on computed risk scores, translating continuous risk values into discrete action recommendations through threshold-based rules, decision trees, or policy-gradient reinforcement learning. The rules engine 243 functions as the policy generation engine, deriving enforcement directives based on computed risk scores. Enforcement directives specify recommended actions such as allow, challenge, throttle, or block, along with associated parameters such as challenge difficulty levels or throttling rates. The model training subsystem 246 updates ML detection models using labeled historical outcomes, where labels are derived from multiple sources including explicit fraud reports, chargebacks, account recovery requests, and implicit signals such as user responses to cryptographic challenges. The model training subsystem 246 employs supervised learning techniques including gradient boosting, random forests, neural networks, and ensemble methods, with regular retraining cycles to adapt to evolving attack patterns. A distribution interface transmits updated models 248 and policies 248 from the risk and anomaly analysis layer 240 to the plurality of edge enforcement nodes 220 through push mechanisms, incremental updates, or versioned model registries, thereby ensuring that edge caches remain synchronized with current threat intelligence while minimizing bandwidth consumption through delta compression and selective distribution.

The decision API and enforcement layer 250 comprises a decision response generator 251, step-up authentication component 252, soft friction controls 253, and hard enforcement actions 254. The decision response generator 251 aggregates risk scores from multiple detection sources, applies business logic to determine final enforcement actions, and generates structured decision responses containing action type, confidence level, explanation text, and remediation guidance. The decision API and enforcement layer 250 additionally includes the explainability and audit framework 247 (which may be part of the risk and anomaly analysis layer 240 as shown in FIG. 2) that generates human-interpretable explanations for risk decisions using techniques such as SHAP values, LIME, or attention mechanisms, supporting compliance requirements and fraud investigation workflows.

In embodiments employing neural network detection models comprising attention layers, such as transformer-based architectures or self-attention mechanisms applied to behavioral feature sequences, the explainability and audit framework 247 additionally generates explanations through attention weight visualization, wherein attention weight matrices are extracted from trained model layers and normalized to produce scalar importance scores for each input feature or temporal position in the input sequence. For example, in a sequence model processing a series of behavioral events within a session, attention weights may reveal that the model assigned disproportionate importance to keystroke timing features at positions corresponding to credential entry, or to geographic location changes occurring mid-session, thereby providing human-interpretable explanations of which temporal patterns drove elevated risk scores. Attention-based explanations are stored alongside SHAP values and LIME approximations in the audit log, enabling fraud analysts and compliance personnel to select the explanation format most suitable for their investigative or regulatory reporting requirements.

The online feature store 241 maintains precomputed feature values for rapid access during real-time scoring. The model serving infrastructure 242 provides low-latency model inference through optimized runtime environments and hardware acceleration. Further, the case management system 245 enables human analysts to review flagged transactions, provide feedback, and override automated decisions. In some aspects, the enforcement controls include the step-up authentication component 252 that demands additional verification factors, the soft friction controls 253 such as warnings or verification delays that increase user friction without complete blocking, and the hard enforcement actions 254 including definitive request denial and account suspension.

The architecture 200 illustrated in FIG. 2 further comprises bidirectional communication paths between layers. Privacy-preserving signals 215 flow from the client application layer 210 to the edge layer 220. Event streams 225 flow from the edge layer 220 to the streaming layer 230. Enriched events and features 235 flow from the streaming layer 230 to the risk and anomaly analysis layer 240. Risk scores and actions 245 flow from the risk and anomaly analysis layer 240 to the decision API and enforcement layer 250. The decision API and enforcement layer 250 communicates enforcement decisions back to edge enforcement nodes 220 and may also provide authentication challenges 255 back to the client application layer 210. Feedback loops include labels 246 flowing from case management 245 to the model training subsystem 246, updated models flowing from the model training subsystem 246 to edge enforcement nodes 220, and policy updates 248 flowing from the decision layer 250 to the edge layer 220. This distributed architecture enables scalable, low-latency threat detection while maintaining operational resilience through layered independence and distributed intelligence.

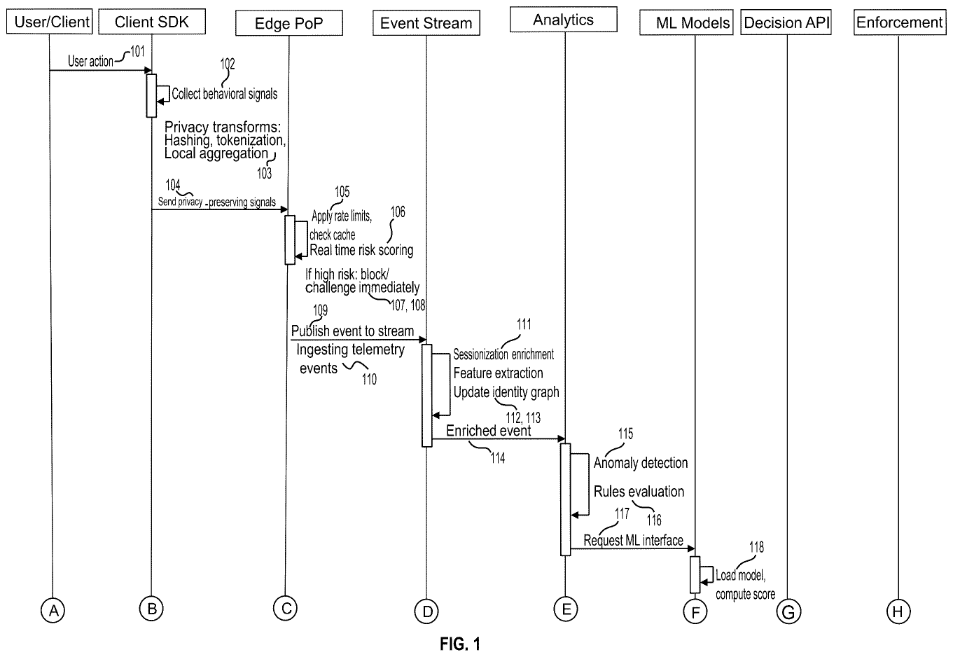

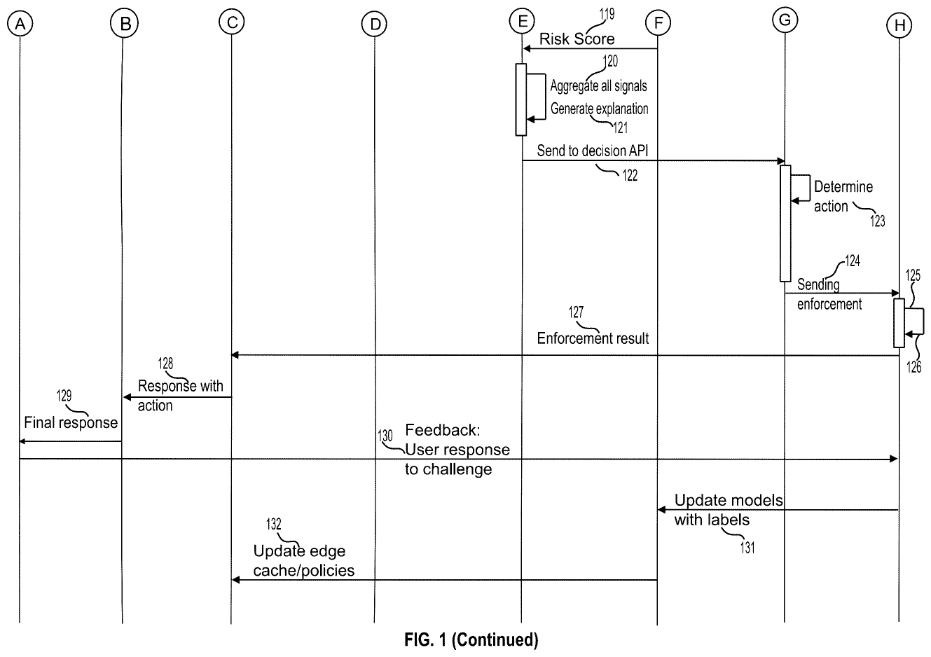

Referring now to FIG. 1, a sequence diagram depicts the operational flow of the system during a typical transaction, depicting the interactions between components of the system of FIG. 2 and the temporal progression of data processing through the distributed architecture. The sequence begins when a user initiates an action such as login authentication, payment transaction submission, account registration, password reset request, or sensitive data access. At initial stage, the user's client device, executing within a web browser, mobile application, or desktop software environment, triggers the client-side instrumentation module.

The client-side instrumentation module, embedded as JavaScript code in web contexts or native binary libraries in mobile applications, begins collecting behavioral signals through multiple observation mechanisms. Input timing patterns are captured by monitoring keystroke events, measuring inter-key latencies with microsecond precision using high-resolution timestamps such as performance.now( ) in web environments or CACurrentMediaTime( ) in iOS applications. The SDK records key-down to key-up durations, dwell times between successive keypresses, and typing rhythm characteristics that form unique biometric signatures. In specific aspects, gesture dynamics are observed through mouse movement trajectory recording, capturing X-Y coordinate pairs at sampling rates between 60Hz and 120Hz, computing velocity vectors, acceleration profiles, and curvature metrics that characterize natural human motor control patterns versus automated bot movements.

In some aspects, for touch-enabled devices, the SDK captures pressure sensitivity values, contact area measurements, and multi-touch gesture patterns. In some aspects, navigation sequences are tracked by recording the temporal order of page visits, element interaction sequences, scroll depth progression, and hover behavior patterns. Application state transitions are monitored including focus changes, visibility state alterations, and background-foreground transitions. In some aspects, device integrity indicators are collected through JavaScript-accessible APIs including navigator.hardwareConcurrency for CPU core count, navigator.deviceMemory for RAM capacity, screen.width and screen.height for display dimensions, and WebGL renderer strings for graphics capabilities.

The SDK performs active probing to detect debugging tools through timing attacks on console. log execution, debugger statement detection, and function redefinition checks. Execution environment attributes are fingerprinted including browser version strings from navigator. userAgent, installed plugin enumeration through navigator. plugins, canvas fingerprinting via rendering-based hashing, AudioContext fingerprinting through audio processing characteristics, and WebRTC-based local IP address discovery.

A behavioral feature data generation process aggregates these raw observations into higher-level statistical representations. Temporal analysis computes rolling statistics over sliding time windows, calculating mean inter-keystroke intervals, standard deviations of mouse movement velocities, and autocorrelation functions that capture rhythmic patterns. The SDK generates feature vectors comprising hundreds of dimensions, with each dimension representing a specific behavioral characteristic such as average typing speed in characters per minute, maximum mouse acceleration in pixels per second squared, or frequency of backspace key usage. These feature vectors are stored temporarily in client-side memory buffers with capacity limits between 1 KB and 10 KB to prevent excessive memory consumption.

The privacy layer performs irreversible transformations to convert behavioral feature data into privacy-preserving feature representations. Cryptographic hashing applies one-way hash functions such as SHA-256 or BLAKE2b to device identifier strings, producing fixed-length 256-bit digests that uniquely identify devices without revealing original values. For instance, a device identifier “Mozilla/5.0 (Windows NT 10.0; Win64; x64) AppleWebKit/537.36” is hashed to produce a hexadecimal string such as “a3f5b8c2d1e4f6a8b9c0d1e2f3a4b5c6d7e8f9a0b1c2d3e4f5a6b7c8d9e0f1a2” that cannot be reversed to recover the original user agent string. Tokenization replaces sensitive categorical values with random identifiers drawn from cryptographically secure pseudorandom number generators, mapping each unique value to a consistent token across sessions while preventing external parties from determining the original values.

In one embodiment, dimensional compression is performed by applying principal component analysis algorithms that project high-dimensional feature vectors into lower-dimensional subspaces, typically reducing dimensionality from 500 dimensions to 50 dimensions while preserving 95 percent or more of the variance in the original data. The compression transformation matrix is computed during an offline training phase using representative behavioral data samples and deployed to client devices as part of the SDK initialization. Alternatively, autoencoder neural networks with bottleneck architectures, trained using backpropagation and mean squared error loss functions, compress input feature vectors through encoder networks comprising fully connected layers with ReLU activation functions, producing compact latent representations of 32 to 128 dimensions. In specific aspects, statistical noise injection implements differential privacy mechanisms by adding calibrated Gaussian or Laplacian noise to numerical feature values, with noise magnitude determined by privacy budget parameters epsilon and delta, balancing privacy protection strength against utility preservation. For example, a typing speed feature value of 247 characters per minute might have Gaussian noise with standard deviation 10 added, producing a transmitted value of 253 characters per minute. Cryptographic encoding schemes apply homomorphic encryption primitives such as the Paillier cryptosystem or lattice-based encryption that allow arithmetic operations on encrypted values, enabling the edge enforcement nodes to perform limited computations on encrypted features without decrypting them.

The privacy-preserving feature representations are transmitted over secured communication channels established using Transport Layer Security protocol version 1.3, employing cipher suites that provide 256-bit AES-GCM symmetric encryption with authenticated encryption and associated data, protecting confidentiality and integrity during transit. The transmission payload comprises a JSON or Protocol Buffers serialized data structure containing the transformed feature vector, timestamp metadata with millisecond precision in ISO 8601 format or Unix epoch time, session identifier as a UUID version 4 random identifier, and optional request context including intended action type and target resource identifiers. The client constructs an HTTPS POST request to an edge enforcement node endpoint URL, including the payload in the request body and setting appropriate headers such as Content-Type: application/json and Accept-Encoding: gzip to enable compression.

The edge point of presence, geographically positioned to minimize network latency to the requesting client, receives the incoming request at its request interception component. The interception occurs at the application layer through reverse proxy software such as NGINX, Envoy, or HAProxy configured with Lua scripting extensions or WebAssembly modules that extract request metadata and invoke the real-time scoring engine. The edge PoP applies rate limiting checks using algorithms such as token bucket or leaky bucket implementations with per-IP-address counters stored in local Redis or Memcached instances, enforcing limits such as 100 requests per minute per IP address or 20 login attempts per hour per account identifier. If rate limits are exceeded, the edge PoP immediately returns HTTP status code 429 Too Many Requests with Retry-After header indicating the time until the rate limit window resets.

The edge PoP consults its local cache, implemented using in-memory data structures with least-recently-used eviction policies and time-to-live expiration, to check for previously computed risk assessments associated with the requesting device identifier hash or session identifier. Cache keys are constructed by concatenating identifier values with action types, such as “login: a3f5b8c2d1e4” for login actions from a specific device. If a cached risk score exists with timestamp within the validity window, typically 60 to 300 seconds, and the cached score is below the blocking threshold, the edge PoP may proceed directly to allow the request without recomputing risk, reducing latency from 15-20 milliseconds to 1-2 milliseconds. Cache hit rates in production deployments typically range from 40 percent to 70 percent depending on request patterns and cache sizing.

When cache miss occurs or cached values have expired, the edge PoP performs real-time risk scoring using locally deployed detection models. The models are serialized in formats such as ONNX (Open Neural Network Exchange), PMML (Predictive Model Markup Language), or proprietary formats like XGBoost binary serialization, and loaded into memory during edge node initialization. Model inference is performed using optimized runtime libraries such as ONNX Runtime, TensorFlow Lite, or custom implementations with SIMD (Single Instruction Multiple Data) vectorization and hardware acceleration through AVX2 or AVX-512 instruction sets on x86_64 processors, or NEON instructions on ARM processors. For gradient boosted decision tree models with 500 to 2000 trees and maximum depth 6 to 10, inference latency is typically 2 to 8 milliseconds on modern server CPUs. For neural network models with architectures comprising 3 to 5 fully connected layers with 128 to 512 neurons per layer and ReLU activations, inference latency ranges from 5 to 15 milliseconds. The models consume input features extracted from the transmitted privacy-preserving feature vectors, combined with locally available contextual features such as request IP address, HTTP headers, TLS handshake characteristics, and timestamp. Model output is a continuous risk score value typically normalized to range 0.0 to 1.0, representing estimated probability of malicious activity, or an integer risk score from 0 to 100.

If the computed risk score exceeds a high-risk threshold value, typically configured at 0.85 to 0.95 for blocking decisions or 0.70 to 0.85 for challenge issuance, the edge PoP immediately executes enforcement without waiting for central analysis. For block enforcement, the edge PoP generates an HTTP response with status code 403 Forbidden or 401 Unauthorized, including a response body containing JSON-formatted error message such as {“error”: “request_blocked”, “reason”: “suspicious_activity”, “request_id”: “req_7f3a9b2c”} that enables client-side error handling and provides correlation identifiers for support inquiries. For challenge issuance, the edge PoP returns HTTP status 200 OK with response body containing a CAPTCHA challenge specification including challenge type (reCAPTCHA v2, reCAPTCHA v3, hCaptcha, image recognition, puzzle solving), challenge payload (image data, JavaScript URL, cryptographic parameters), and session token that must be included in the subsequent verification request. The cryptographic challenge may comprise a proof-of-work computation requiring the client to find a nonce value such that the SHA-256 hash of the concatenation of the challenge string, nonce, and client data has a specified number of leading zero bits, typically 16 to 24 bits, requiring expected computation time of 1 to 10 seconds on client CPUs.

Concurrently, with enforcement decision execution, the edge PoP publishes telemetry events to the streaming layer through asynchronous message transmission that does not block the response to the client. The telemetry generation component 223 constructs event records containing request metadata including timestamp with nanosecond precision, source IP address, requested URL path, HTTP method, user agent string, referer header, session identifier, device identifier hash, computed risk score, enforcement action taken, latency measurements broken down by processing stages (cache lookup, model inference, response generation), and model version identifier. The event record is serialized using efficient binary formats such as Apache Avro or Protocol Buffers that reduce serialization overhead and network bandwidth consumption compared to JSON encoding. The edge PoP transmits events to the streaming platform using producer APIs with batching configured to accumulate 10 to 100 events or 100 KB to 1 MB of data before transmission, balancing throughput optimization against latency sensitivity. In some aspects, network transmission employs TCP connections with connection pooling and HTTP/2 or gRPC protocols with multiplexing to reduce connection establishment overhead. Producer acknowledgment is configured for “at least once” delivery semantics where the producer waits for acknowledgment from the streaming platform leader replica before considering the send complete, or “fire and forget” semantics for lower latency at the cost of potential message loss under failure conditions.

In some aspects, the streaming layer receives telemetry events into distributed message queues partitioned by key values such as session identifier or device identifier hash to ensure that related events are processed by the same consumer instances, maintaining ordering guarantees necessary for temporal sequence analysis. The streaming layer, implemented using Apache Kafka with topic replication factor of 3 and minimum in-sync replicas of 2 for durability, or Amazon Kinesis with enhanced fan-out and on-demand capacity mode, stores events in append-only logs with retention periods of 7 to 30 days enabling replay for model retraining or incident investigation. Sessionization consumer applications subscribe to event topics and perform stateful stream processing using frameworks such as Apache Flink, Apache Kafka Streams, or Apache Spark Structured Streaming. Sessionization groups events by session identifier and applies windowing functions with session gap timeout of 30 minutes, meaning that events separated by more than 30 minutes of inactivity are assigned to different session windows. Within each session window, events are ordered by timestamp and aggregated to compute session-level statistics such as total request count, distinct device count, geographic location changes, user agent variations, and behavioral anomaly scores.

An enrichment pipeline augments ingested events with derived network attributes by performing lookups against reference databases and external services. Geographic region determination utilizes MaxMind GeoIP2 or IP2Location databases that map IP address CIDR blocks to geographic coordinates, city names, country codes, and postal codes, with lookup latency of 0.1 to 1 millisecond for in-memory databases. Autonomous system number lookup queries Border Gateway Protocol routing tables from Regional Internet Registries to determine the AS number and organization name associated with the source IP address, identifying hosting providers, cloud platforms, or corporate networks. Protocol fingerprinting extracts TLS handshake parameters including cipher suites ordered by client preference, supported TLS versions, server name indication values, ALPN protocol lists, and certificate chain characteristics, computing JA3 fingerprints as MD5 hashes of concatenated parameter strings that uniquely identify client software implementations. Enriched events are written to output topics or database tables with additional fields populated, thereby increasing event size from 1 KB to 3 KB but providing substantially enhanced analytical context.

In some aspects, feature extraction components compute additional derived features from enriched events including velocity metrics that measure the rate of specific actions over time windows. In some aspects, login attempt velocity is computed by counting login events for a given account identifier within sliding windows of 5 minutes, 1 hour, and 24 hours, detecting anomalous spike patterns indicative of credential stuffing attacks where hundreds of login attempts occur within minutes. Geographic velocity detects physically impossible travel by comparing successive login locations and timestamps, flagging cases where a user appears to log in from New York at 10:00 AM and from London at 10:05 AM, indicating account sharing or credential compromise. Pattern anomaly scores are computed by comparing current behavioral features against historical profiles using statistical distance measures, with scores above 3 to 5 standard deviations indicating significant deviations from normal behavior.

In one aspect, the identity graph is updated with new entity nodes and relationship edges reflecting the current event through graph database operations performed on systems such as Neo4j, Amazon Neptune, or TigerGraph. When an event contains a previously unseen device identifier hash, a new device node is created with properties including first_seen timestamp, last_seen timestamp, device_type derived from user agent parsing, and operating_system version. Relationship edges are inferred by analyzing entity co-occurrence patterns. If the current event shows device D1 accessing account A1, and the graph already contains a relationship between device D2 and account A1 from a previous session occurring within the past 7 days, a new edge is created between D1 and D2 with relationship type “shares_account” and edge weight initially set to 0.5. Edge weights are incremented by 0.1 for each additional co-occurrence, up to a maximum of 1.0, while weights decay by multiplying by 0.95 every 24 hours without reinforcement, causing edges to weaken and eventually be pruned when weights fall below 0.1. Graph algorithms execute periodically, such as every 5 minutes or hourly, to identify community structures using Louvain modularity optimization or label propagation, detecting tightly connected clusters of devices and accounts that may represent coordinated bot networks or fraud rings.

Enriched events with computed features and graph context are delivered to the risk and anomaly analysis layer through subscription-based consumption. In some aspects, anomaly detection engines apply multiple detection methodologies operating in parallel. Statistical anomaly detection uses Z-score calculations comparing current feature values against historical distributions, flagging values more than 3 standard deviations from the mean as anomalous. Isolation forest algorithms, trained on historical benign traffic samples comprising millions of events, assign anomaly scores based on the average path length required to isolate each sample in random forest trees, with shorter path lengths indicating anomalies. One-class support vector machines trained to recognize the boundary of normal behavior in high-dimensional feature space flag samples falling outside the learned decision boundary. In some aspects, time series anomaly detection is performed using autoregressive models or LSTM recurrent neural networks that predicts expected feature values based on historical temporal patterns and flags significant prediction errors as anomalies.

The rules evaluation engine applies hand-crafted detection rules encoded in domain-specific languages or rule engines such as Drools or Easy Rules. Rules encode known attack signatures and business logic constraints. Example rules include: IF login_velocity_5min>50 AND account_age_days<7 THEN flag as potential_bot_signup with severity HIGH; IF geo_velocity_km_per_hour>800 THEN flag as impossible_travel with severity CRITICAL; IF device_count_per_account_24h>10 THEN flag as account_sharing with severity MEDIUM. Rules are evaluated using forward chaining inference where facts derived from events are pattern-matched against rule conditions, with matching rules firing to assert new derived facts or generate alerts. Rule evaluation latency is typically sub-millisecond for rule sets containing hundreds to thousands of rules.

The ML interface loads appropriate detection models from the model store, implemented using model registries such as MLflow Model Registry, Seldon Core, or custom S3-based storage with version management. Model selection logic chooses models based on request context, such as different models for login versus payment transactions, or A/B testing configurations that route percentage traffic splits to experimental model versions. The ML interface extracts graph-based features from the identity graph through Cypher queries in Neo4j or Gremlin traversals in TinkerPop-compatible systems. Graph features include node degree (count of directly connected entities), betweenness centrality (frequency of node appearance on shortest paths), PageRank scores adapted for entity importance ranking, clustering coefficients measuring local graph density, and shortest path distances to known malicious entities flagged in previous investigations. These graph features are concatenated with behavioral features and contextual features to form comprehensive input feature vectors of 200 to 500 dimensions. Model inference produces risk scores along with contribution scores for individual features computed through SHAP value calculation or integrated gradients, enabling explainability.

The aggregated signals from anomaly detectors, rule engines, and machine learning models are sent to the decision API through RESTful HTTP requests or gRPC calls. The decision API, implemented as a microservice with horizontal autoscaling based on request rate, applies business logic to determine the final recommended enforcement action. Decision logic implements threshold-based rules. The decision API considers contextual factors including account value (high-value accounts may receive lower friction), user history (established users with clean records may receive higher risk tolerance thresholds), regulatory requirements (certain jurisdictions may mandate additional verification), and business policies (promotional campaigns may relax restrictions temporarily). The decision includes action type enumeration, human-readable explanation strings concatenating top contributing factors such as “Blocked due to: impossible geographic travel (New York to London in 5 minutes), high login velocity (73 attempts in last hour), device never seen before for this account”, confidence level as a percentage, and suggested remediation steps for legitimate users incorrectly flagged. Decisions are logged to audit databases with retention periods meeting regulatory requirements of 5 to 7 years for financial institutions.

The enforcement result is transmitted back to the originating edge PoP through response messages on request-response communication channels or through publish-subscribe topics if the decision arrived asynchronously after the edge PoP has already responded to the client. When asynchronous decisions arrive indicating higher risk than initially assessed, the edge PoP may invalidate the issued session token or mark the account for additional verification on the next request. The edge PoP executes the specified enforcement action by generating appropriate HTTP responses to the waiting client connection. For approval actions, the edge PoP proxies the request to the upstream application server, potentially adding custom headers such as X-Risk-Score: 0.23 and X-Request-ID: req_7f3a9b2c that enable application-layer logging and correlation. For challenge actions, the edge PoP returns JavaScript code that renders the challenge UI, initializes CAPTCHA widgets, or executes proof-of-work computations, along with callback URLs for submitting challenge responses. For denial actions, the edge PoP closes the connection or returns terminal error responses.

User responses to challenges, such as CAPTCHA solution attempts, provide labeled feedback that is stored as training data for future model updates. When a user successfully solves a CAPTCHA challenge, the system infers that the original request was likely legitimate despite the elevated risk score, creating a negative training example (human user, not bot) with features from that request. Conversely, failure to solve challenges or abandonment of the flow provides positive signal for malicious classification. Challenge response data is stored in training data repositories implemented on distributed file systems such as HDFS or cloud object storage such as Amazon S3, organized in partitions by date and labeled with outcome classifications. Automated labeling pipelines merge challenge outcomes with downstream fraud signals such as chargeback notifications, account lockout events from customer support, or successful transaction completions, enriching training datasets with multi-source ground truth labels. The model training subsystem periodically retrains detection models, typically on daily or weekly schedules, using the accumulated labeled data through distributed training frameworks such as Apache Spark MLlib, Dask-ML, or Ray Train that parallelize training across compute clusters. Training employs techniques such as stratified sampling to balance class distributions, cross-validation with 5 or 10 folds to assess generalization performance, and hyperparameter tuning using Bayesian optimization or grid search.

Edge cache and policy updates are propagated asynchronously to ensure edge nodes maintain current threat intelligence without disrupting active request processing. The distribution interface in the risk intelligence platform 240 monitors for model version changes, policy modifications, or threat indicator updates such as newly identified malicious IP addresses or compromised credential hashes. When updates are available, the distribution interface constructs delta packages containing only changed data elements, compressing packages using gzip or zstd compression algorithms achieving 5:1 to 10:1 compression ratios. Distribution employs content delivery networks or peer-to-peer distribution protocols to transmit updates to thousands of edge nodes globally within 30 seconds to 5 minutes, with gradual rollout strategies that update 10 percent of edge nodes initially, monitoring for error rate increases or performance degradation before proceeding to full deployment. Edge nodes subscribe to update notification channels implemented through Server-Sent Events, WebSocket connections, or polling intervals of 30 to 60 seconds, downloading and applying updates atomically during brief maintenance windows that do not interrupt request processing. Blue-green deployment patterns maintain two complete model environments, switching traffic from the old version to the new version instantaneously once validation checks confirm successful loading and initialization. This operational flow, as illustrated in FIG. 1, demonstrates the intricate coordination between distributed system components operating at multiple layers to achieve real-time malicious activity detection with privacy preservation, adaptive learning, and autonomous enforcement capabilities.

To further illustrate the practical application of the invention, consider the following non-limiting example implementation in the context of a financial services platform processing login and payment transactions. In this example implementation, the platform serves millions of users globally and faces threats including credential stuffing attacks, account takeover campaigns, payment card fraud, and automated scraping of account balance information.

The behavioral SDK 211 is deployed as an obfuscated JavaScript library loaded by the platform's web application on every page. When a user navigates to the login page, the SDK begins passively collecting behavioral signals including keystroke timing as the user types credentials, mouse movement trajectories as the user moves between input fields, and scroll behavior on the page. The SDK records that the current user typed their username in 1.8 seconds with normal inter-keystroke variability characteristic of human typing, moved the mouse cursor from the username field to the password field along a natural curved trajectory, and demonstrated touch pad micro-tremors consistent with human motor control. These observations are aggregated into a 500-dimensional behavioral feature vector.

The privacy layer 212 transforms this feature vector by: applying SHA-256 hashing to the device fingerprint string, reducing the 500-dimensional vector to 50 dimensions using a pre-deployed PCA transformation matrix, adding Laplacian noise with scale parameter 0.3 to velocity features, and replacing the session token with a randomly generated UUID. The resulting 50-dimensional privacy-preserving vector is serialized as Protocol Buffers and transmitted via TLS 1.3 to the nearest edge PoP, which in this example is located in a data center 15 milliseconds of network latency from the user.

The edge enforcement node 220 receives the login request and privacy-preserving feature vector simultaneously. The policy execution component 221 checks rate limiting counters and finds the source IP has made only 2 login attempts in the past hour, well below the threshold of 20 attempts per hour. The local cache is checked and returns no recent risk assessment for this device fingerprint hash. The real-time scoring engine 222 loads its locally cached gradient boosted tree model and runs inference in 4 milliseconds, producing a preliminary risk score of 0.18, indicating low risk. Since this score is below the blocking threshold of 0.85 and challenge threshold of 0.70, the edge PoP allows the request to proceed to application servers while simultaneously publishing a telemetry event to the streaming layer 230.

Meanwhile, the streaming layer 230 ingests the telemetry event and enriches it: the MaxMind database identifies the source IP as a residential ISP address in Chicago, matching the user's registered location; the ASN lookup identifies Comcast Business as the provider; and the JA3 fingerprint matches Chrome 119 on Windows 11, consistent with the user's registered devices. The sessionization component 232 groups this login event with 12 prior events from the same session. The identity graph builder 234 confirms that the device fingerprint hash has been associated with this account for the past 14 months with 847 historical interactions, a strong positive signal of account ownership.

The risk and anomaly analysis layer 240 retrieves features from the online feature store 241 showing that this account has a clean fraud history, the device is well-established, the geographic location is consistent, and the behavioral profile matches historical patterns within 1.2 standard deviations. The model serving component 242 produces a comprehensive risk score of 0.12. The rules engine 243 finds no matching fraud rules. The decision API and enforcement layer 250 determines the action as “allow without friction,” and the user is logged in seamlessly without any CAPTCHA or MFA prompt, completing the forward path in 95 milliseconds total end-to-end latency.

In contrast, consider a concurrent attack scenario where a threat actor uses a credential stuffing tool loaded with 50,000 stolen username-password pairs obtained from a data breach of an unrelated service. The attack tool, running on a cloud server, sends login requests at a rate of 300 per minute. The behavioral SDK 211 deployed on the attacker's automated browser records: keystrokes typed at exactly 250 milliseconds per character with zero variability (characteristic of programmatic text insertion), mouse movements that move in perfectly straight lines at constant velocity, and no scroll behavior or hover events. The privacy layer 212 transforms these signals, but the statistical features—zero entropy in keystroke timing, zero curvature in mouse trajectories—are preserved through the PCA transformation.

At the edge enforcement node 220, the rate limiting check immediately detects 73 login attempts from the source IP in the past 5 minutes, exceeding the threshold of 20 per hour. The policy execution component 221 issues an HTTP 429 Too Many Requests response without consulting backend systems. For attempts arriving from different IP addresses within the same attack campaign, the real-time scoring engine 222 produces risk scores of 0.91 to 0.97 based on the robotic behavioral features, triggering immediate CAPTCHA challenge issuance. Telemetry events from all attack requests are published to the streaming layer 230.

The streaming layer 230 detects a velocity anomaly: 847 login events for various accounts from cloud datacenter IP ranges within a 10-minute window, exceeding the expected baseline of 20 per window by 42 standard deviations. The identity graph builder 234 creates new device nodes for each attacker IP and establishes edges linking them through shared attack timing patterns and sequential account targeting behavior. Community detection identifies these IPs as a coordinated cluster. The anomaly detection engines 244 flag the pattern as a high-confidence credential stuffing attack. The decision API and enforcement layer 250 issues an emergency policy update 248 to all edge enforcement nodes 220 instructing them to block all requests from the identified IP ranges and require step-up authentication 252 for any account that received a failed login attempt during the attack window. This policy update propagates to all edge nodes within 45 seconds, blocking the attack globally before significant account compromise can occur.

This example implementation demonstrates how the architecture 200 achieves the dual objectives of frictionless user experience for legitimate users (95 millisecond login with no challenges) and rapid, automated protection against sophisticated attacks (45-second global policy propagation blocking credential stuffing), validating the practical benefits of the distributed edge-first approach.

According to another embodiment, the present invention provides a computer-implemented method for detecting and preventing malicious digital activity in distributed computing environments, the method comprising a sequence of coordinated operations executed across client devices, edge enforcement nodes, streaming layer, analytical platforms, and decision systems as illustrated in the sequence diagram of FIG. 1.

The method begins with a user action 101 performed at the User/Client, followed by collecting behavioral signals 102 at the client-side instrumentation module on a user device by observing user interaction patterns through instrumentation code embedded within client-side applications. The observing comprises monitoring input timing characteristics by capturing keystroke events with associated timing metadata, wherein each keypress generates an event record containing key identifier, key-down timestamp with microsecond precision, key-up timestamp, and computed dwell time representing the duration between key-down and key-up events. The monitoring further includes measuring inter-keystroke intervals by calculating time differences between successive key-down events, building temporal sequences that characterize typing rhythm and cadence. The observing additionally comprises tracking gesture dynamics by sampling mouse position coordinates at regular intervals ranging from 60 to 120 samples per second, computing instantaneous velocity vectors by differentiating position with respect to time, calculating acceleration vectors by differentiating velocity, and analyzing trajectory curvature through geometric computations on coordinate sequences. For touch-enabled devices, the observing includes capturing touch event properties such as pressure values normalized to range 0.0 to 1.0, contact area measurements in pixels, touch radius estimates, and multi-touch gesture patterns including pinch, zoom, and rotation.

The observing further comprises recording navigation behaviors by logging page load events with timestamps and URLs, element click events with target element identifiers and screen coordinates, scroll events with vertical and horizontal displacement values, and hover duration measurements indicating time spent with cursor positioned over specific elements. The observing additionally comprises monitoring application state transitions including window focus changes, tab visibility alterations detected through Page Visibility API, and background-foreground transitions in mobile applications. The observing further comprises collecting device integrity indicators by executing fingerprinting operations that enumerate system properties including processor core count, available memory capacity, screen resolution dimensions, installed browser plugins with names and versions, supported MIME types, and graphics renderer identification strings. The collecting 102 aggregates observed events into temporary in-memory data structures with bounded capacity limits to prevent excessive resource consumption, maintaining circular buffers that retain most recent observations while discarding oldest entries when capacity is exceeded.

The method further comprises privacy transforms 103 executed by the Privacy Layer, said step comprising transforming said behavioral telemetry into privacy-preserving feature vectors on the user device prior to network transmission, thereby ensuring that raw behavioral data and personally identifiable information remain exclusively on the client device and are never transmitted across network boundaries. The privacy transforms 103 comprise applying irreversible transformation functions that prevent recovery of original data values from transmitted representations. The applying includes executing cryptographic hash functions selected from SHA-256, SHA-512, or BLAKE2b algorithms on sensitive string values such as device identifiers, user agent strings, and installed plugin lists, wherein each unique input value consistently maps to the same fixed-length output digest while computational infeasibility prevents determination of the input from the output. The applying further includes performing dimensional reduction through principal component analysis by multiplying high-dimensional feature vectors with pre-computed transformation matrices to produce lower-dimensional projections, wherein the transformation matrices are derived during offline training phases using representative behavioral datasets and deployed to client devices as part of initialization procedures.

Alternatively, the dimensional reduction employs autoencoder neural network architectures comprising encoder layers that compress input vectors into bottleneck representations and decoder layers that reconstruct outputs, wherein only the encoder portion executes on client devices to generate compact privacy-preserving feature representations. The applying additionally includes injecting statistical noise through differential privacy mechanisms by adding random perturbations drawn from Laplacian or Gaussian distributions with magnitude calibrated according to privacy budget parameters, wherein noise addition prevents precise reconstruction of original feature values while preserving statistical properties enabling effective risk assessment. The applying further includes executing tokenization schemes that replace categorical values with randomly generated identifiers, maintaining consistent mappings such that repeated occurrences of the same value produce the same token while preventing external observers from determining the original values. The privacy transforms 103 construct feature vectors by organizing transformed values into ordered numeric arrays with each dimension corresponding to a specific behavioral characteristic, creating compact binary representations suitable for efficient network transmission. The privacy transforms 103 explicitly suppress inclusion of raw interaction data, personally identifiable user names, email addresses, payment credentials, and unprocessed biometric measurements in transmitted payloads.

The method additionally comprises sending privacy-preserving signals 104 from the client-side instrumentation module to the Edge PoP, said step comprising transmitting the privacy-preserving feature vectors to an event streaming platform over secured communication channels established using cryptographic protocols. The sending 104 comprises establishing Transport Layer Security connections using TLS protocol version 1.2 or higher with cipher suites providing authenticated encryption, negotiating encryption parameters through handshake procedures that exchange certificates and establish session keys, and encrypting application data using symmetric algorithms with key lengths of at least 128 bits.

The transmitting 104 further comprises serializing feature vectors into compact binary formats such as Protocol Buffers or Apache Avro that reduce payload size compared to text-based JSON encoding, incorporating message framing headers that specify payload length and schema version identifiers. The transmitting 104 additionally comprises constructing HTTPS POST requests directed to edge enforcement node endpoints, populating request bodies with serialized feature vector payloads, and setting HTTP headers including Content-Type specifications indicating payload format and Accept-Encoding directives enabling compression. The transmitting 104 includes associating metadata with feature vectors comprising timestamp values with millisecond or microsecond precision formatted as Unix epoch time or ISO 8601 strings, session identifiers generated as random UUID version 4 values providing globally unique identification without coordination, and optional context parameters indicating intended action types such as login, payment, or data access.

The method further comprises applying rate limits and checking cache 105 at the Edge PoP, said step comprising intercepting application-layer requests at edge enforcement nodes positioned at network ingress locations, the intercepting occurring prior to routing requests to backend application servers. The step 105 comprises receiving incoming HTTP or HTTPS requests at reverse proxy servers executing at edge locations, parsing request headers to extract source IP addresses, HTTP methods, URL paths, user agent strings, and cookie values, and extracting request bodies containing feature vector payloads transmitted from client devices. The step 105 additionally comprises applying rate limiting checks by querying request counters stored in local in-memory databases, incrementing counters associated with client identifiers such as IP addresses or session tokens, comparing counter values against configured threshold limits specifying maximum permitted request rates within time windows, and returning rate limit exceeded responses when thresholds are breached. The step 105 further comprises consulting local cache storage to determine whether previously computed risk assessments exist for the requesting entity, the consulting comprising constructing cache lookup keys by concatenating entity identifiers with action type indicators, querying key-value stores implemented using Redis or Memcached technologies, retrieving cached risk score values if present, and evaluating cache entry validity by comparing current timestamp against cached timestamp plus configured time-to-live duration.

The method additionally comprises real-time scoring 106 at the Edge PoP, said step comprising computing preliminary risk assessments at edge nodes using locally deployed machine learning models when cache misses occur or cached entries have expired. The real-time scoring 106 comprises loading serialized model artifacts from local file systems into runtime memory during edge node initialization, wherein model formats include ONNX, PMML, or framework-specific binary serializations. The scoring 106 further comprises extracting input features from received feature vector payloads and locally available request context including source IP address, HTTP headers, TLS handshake parameters, and request timestamp. The scoring 106 additionally comprises executing model inference through optimized runtime libraries that perform matrix multiplications, apply activation functions, traverse decision tree structures, or evaluate rule conditions depending on model type, producing output values representing risk probability estimates or categorical risk classifications. The scoring 106 includes normalizing output values to standard ranges such as 0.0 to 1.0 for probability scores or 0 to 100 for integer risk ratings.

The method further comprises a conditional decision point 107 where, if the risk score is high, the Edge PoP proceeds to block or challenge immediately 108. The method comprises executing inline enforcement actions 108 at edge nodes independently of centralized decision infrastructure when risk scores exceed high-risk thresholds as determined at decision point 107. The executing 108 comprises generating immediate responses to client connections without waiting for additional analysis from central systems. For blocking enforcement, the executing 108 includes constructing HTTP responses with status codes indicating access denial such as 403 Forbidden or 401 Unauthorized, populating response bodies with structured error messages in JSON or XML format containing error codes, human-readable descriptions, and request correlation identifiers, and transmitting responses to client connections thereby terminating request processing. For challenge enforcement, the executing 108 comprises generating challenge specifications including challenge type identifiers indicating CAPTCHA, proof-of-work, or multi-factor authentication requirements, incorporating challenge payload data such as CAPTCHA image data or cryptographic puzzle parameters, creating unique challenge session tokens, and returning HTTP responses with status code 200 and response bodies containing challenge presentation instructions. For throttling enforcement, the executing 108 includes introducing deliberate processing delays by suspending request handling threads for configured duration intervals, or limiting request processing rate by queuing incoming requests and serving them at controlled rates.

The method further comprises publishing event to stream 109 from the Edge PoP to the Event Stream, said step comprising publishing telemetry events from edge nodes to streaming layer asynchronously without blocking response delivery to clients. The publishing 109 comprises constructing event records containing request metadata, computed risk scores, enforcement actions taken, processing latency measurements, and model version identifiers. The publishing 109 further comprises serializing event records using binary encoding schemes, accumulating multiple events into transmission batches to amortize network overhead, and transmitting batches to message broker endpoints using producer APIs with configurable delivery guarantees. The method additionally comprises ingesting telemetry events 110 at the Event Stream through distributed message queue systems partitioned by key values to ensure related events are processed by consistent consumer instances while maintaining message ordering within partitions. The method further comprises sessionization and enrichment 111 at the Event Stream, said step comprising performing sessionization by grouping events sharing common session identifiers within temporal windows, applying window functions that aggregate events separated by gaps exceeding timeout thresholds into distinct session boundaries, and computing session-level statistics including request counts, distinct device counts, and behavioral consistency metrics.

The sessionization and enrichment 111 additionally comprises correlating received feature vectors with network-derived attributes by performing enrichment operations that augment event data with additional contextual information. The correlating comprises determining geographic location identifiers by querying IP geolocation databases that map IP address ranges to latitude-longitude coordinates, city names, country codes, and region identifiers, the querying executing through in-memory lookup operations with sub-millisecond latency. The correlating further comprises identifying autonomous system numbers by performing lookups against routing tables that associate IP addresses with AS numbers and organization names representing Internet service providers or hosting facilities. The correlating additionally comprises computing protocol fingerprints by extracting TLS handshake parameters including cipher suite preferences, supported protocol versions, and extension values, concatenating extracted parameters into normalized strings, and applying hash functions to produce compact fingerprint identifiers that uniquely characterize client software implementations. The correlating further comprises retrieving IP address reputation scores from threat intelligence databases containing known malicious addresses, Tor exit nodes, datacenter IP ranges, and residential proxy pools, assigning numeric reputation values ranging from highly trusted to highly suspicious. The step 111 writes enriched event records to output topics or database tables with populated attribute fields available for subsequent analytical processing.

The method further comprises feature extraction 112 at the Event Stream, said step comprising extracting derived features from enriched events by computing velocity metrics and pattern anomaly indicators. The extracting 112 comprises calculating login attempt velocities by counting login events associated with specific account identifiers within sliding time windows of varying durations, detecting anomalous spike patterns where event counts exceed expected baselines by statistically significant margins. The extracting 112 additionally comprises computing geographic impossibility scores by comparing successive login locations and timestamps, identifying cases where physical travel between locations would require speeds exceeding realistic transportation capabilities, thereby indicating account sharing or credential compromise. The extracting 112 further comprises calculating pattern deviation scores by comparing current behavioral feature distributions against historical baseline profiles, computing statistical distance measures that quantify dissimilarity, and flagging events exhibiting deviations beyond threshold multiples of standard deviations from historical norms.

The method additionally comprises updating the identity graph 113 at the Event Stream, said step comprising constructing and updating a continuously evolving identity graph by executing graph database operations that create nodes, establish edges, and modify relationship properties based on observed event patterns. The constructing 113 comprises creating entity nodes when previously unseen identifiers appear in events, wherein node types include user nodes representing account identifiers, device nodes representing device fingerprint hashes, session nodes representing session tokens, credential nodes representing authentication factors, and network nodes representing IP addresses or autonomous systems. The constructing 113 further comprises assigning node properties including creation timestamps, last activity timestamps, derived attributes such as device type classifications, and aggregated statistics such as total request counts. The updating 113 comprises inferring relationship edges between nodes by detecting co-occurrence patterns where multiple entity identifiers appear together in related events within temporal proximity, the inferring creating edges with relationship type labels such as “used_by” connecting devices to users, “associated_with” connecting sessions to devices, or “shares_account” connecting devices accessing the same account. The updating 113 further comprises initializing edge weights to fractional values representing relationship strength, incrementing weights by configured amounts when relationships are reinforced through repeated observations, and applying time-decay functions that multiply weights by decay factors less than 1.0 at regular intervals, causing weights to decrease exponentially for relationships not recently active. The updating 113 additionally comprises pruning edges when weights fall below minimum threshold values, thereby removing stale relationships from the graph and maintaining graph sparsity. The method further comprises executing community detection algorithms periodically to identify densely connected subgraphs representing clusters of related entities, applying modularity optimization techniques or label propagation methods that assign community identifiers to nodes based on graph topology.

The method further comprises sending enriched events and features 114 from the Event Stream to the Analytics component. Following this, the method comprises anomaly detection 115 at the Analytics component, said step comprising applying anomaly detection algorithms to enriched event streams to identify unusual patterns indicative of malicious activity. The applying 115 comprises executing statistical anomaly detection by computing z-scores that measure deviations of feature values from historical mean values in units of standard deviations, flagging values exceeding threshold multiples such as 3 or 5 standard deviations as anomalous. The applying 115 additionally comprises running isolation forest algorithms that construct random decision trees and compute anomaly scores based on average path lengths required to isolate samples, wherein anomalous samples require fewer tree traversals for isolation compared to normal samples. The applying 115 further comprises employing one-class support vector machines trained to recognize the boundary of normal behavior in feature space, classifying samples falling outside the learned decision boundary as anomalies. The applying 115 additionally comprises executing time series forecasting models that predict expected feature values based on historical temporal patterns, computing prediction errors by comparing actual observed values against predicted values, and flagging samples with prediction errors exceeding threshold magnitudes as temporal anomalies.

The method additionally comprises rules evaluation 116 at the Analytics component, said step comprising evaluating hand-crafted detection rules encoding known attack signatures and business logic constraints. The evaluating 116 comprises pattern-matching event attributes against rule conditions specified in rule definitions, wherein rules encode logical expressions combining attribute comparisons with Boolean operators. The evaluating 116 further comprises executing forward chaining inference where derived facts asserted by fired rules become available for matching against subsequent rule conditions, enabling multi-step reasoning chains. The evaluating 116 includes associating severity levels with rules indicating relative importance of detected conditions, and generating alert notifications when high-severity rules fire.

The method further comprises requesting ML interface 117 from the Analytics component to the ML Models component. The method additionally comprises loading model and computing score 118 at the ML Models component, said step comprising generating comprehensive risk scores by querying the identity graph to extract graph-based features and combining said features with behavioral features through trained machine learning models. The generating 118 comprises executing graph traversal queries that compute node centrality measures quantifying entity importance based on graph position, calculate edge density statistics measuring local connectivity, determine community membership indicating entity clustering, and compute shortest path distances to known malicious entities. The generating 118 further comprises retrieving behavioral features from feature stores containing pre-computed feature values, and contextual features from event metadata. The generating 118 additionally comprises concatenating graph-based features, behavioral features, and contextual features into input feature vectors, loading trained model artifacts from model registries, executing model inference to produce risk probability estimates or categorical classifications, and normalizing outputs to standard score ranges. The generating 118 includes computing feature contribution scores using explainability techniques that quantify how individual features influence model predictions, enabling transparent decision rationale.

The method additionally comprises returning the risk score 119 from the ML Models component to the Analytics component. The method further comprises aggregating all signals 120 at the Analytics component, said step comprising aggregating signals from multiple detection sources including anomaly detectors (step 115), rules engines (step 116), and machine learning models (steps 117-119). The aggregating 120 comprises collecting output values from parallel detection pathways, associating confidence levels or severity ratings with each signal, and packaging signals into decision request payloads. The method additionally comprises generating explanation 121 at the Analytics component by identifying top contributing factors through explainability analysis and creating human-readable decision rationales.

The method further comprises sending to decision API 122 from the Analytics component to the Decision API, said transmission comprising transmitting aggregated signals and explanations to a decision API for final action determination. The method additionally comprises determining action 123 at the Decision API, said step comprising determining recommended enforcement actions by applying business logic that considers risk scores, business policies specifying risk tolerance levels for different account types or transaction values, regulatory requirements mandating specific verification procedures, and contextual factors including user history and geographic location. The determining 123 comprises evaluating conditional logic that maps risk score ranges to action types, wherein scores exceeding critical thresholds trigger blocking, scores in high-risk ranges trigger challenge presentation, scores in medium ranges trigger monitoring or soft friction, and scores below risk thresholds permit request approval. The determining 123 further comprises generating decision explanations by concatenating top contributing factors identified through explainability analysis in step 121, creating human-readable text describing reasons for enforcement decisions. The determining 123 additionally comprises assigning confidence levels representing certainty in decision correctness, and specifying remediation steps legitimate users can follow if incorrectly classified.

The method further comprises sending enforcement decision 124 from the Decision API to the Enforcement component, said step comprising distributing enforcement directives by transmitting decision messages through response channels or asynchronous messaging systems. The distributing 124 comprises serializing decision structures containing action type enumerations, explanatory text, confidence percentages, and optional parameters such as challenge specifications or throttling rates. The distributing 124 further comprises routing decision messages to the originating edge nodes or enforcement components that will execute the actions, matching responses to pending requests through correlation identifiers.

The method additionally comprises executing enforcement 125 at the Enforcement component, said step comprising executing received enforcement directives by parsing decision messages, extracting action types and parameters, and invoking appropriate response generation functions. The step 125 comprises constructing HTTP responses for allowed requests, generating challenge content for challenged requests, blocking access for denied requests, or applying other enforcement actions as specified in the decision directive.

The method further comprises applying action 126 at the Enforcement component, wherein the determined enforcement action is applied to the request. This may comprise constructing and sending HTTP responses, injecting CAPTCHA challenges, triggering multi-factor authentication flows, blocking access, or forwarding approved requests to backend application servers.

The method additionally comprises sending enforcement result 127 from the Enforcement component to the Edge PoP, communicating the outcome of the enforcement action. The method further comprises sending response with action 128 from the Edge PoP to the client-side instrumentation module, transmitting the HTTP response containing the enforcement result back to the client application. The method additionally comprises delivering final response 129 from the client-side instrumentation module to the User/Client, thereby completing the forward processing path and delivering the result to the end user.

The method further comprises feedback loops illustrated in the lower portion of FIG. 1. The method comprises feedback step 130 comprising transmitting user response to challenge from the User/Client to the Enforcement component, wherein users interact with presented challenges (CAPTCHA, MFA, etc.) and submit responses, generating feedback signals. The method additionally comprises feedback step 131 comprising updating models with labels, said step transmitting feedback data from the Enforcement component to the ML Models component. The step 131 comprises collecting user feedback from challenge interactions by monitoring client responses to presented challenges, wherein successful challenge completion indicates likely legitimate user activity while failure or abandonment suggests automated bot activity or malicious intent. The collecting 131 comprises receiving challenge solution submissions from clients containing CAPTCHA answers or proof-of-work nonce values, validating submissions by checking correctness of answers or verifying hash computations, and recording validation outcomes.

The method further comprises storing training data at the ML Models component, said step comprising storing labeled training examples by associating challenge outcomes with original request features, creating datasets pairing feature vectors with binary labels indicating human versus bot classification or fraud versus legitimate classification. The storing comprises writing labeled examples to distributed storage systems organized in time-based partitions, applying retention policies that maintain training data for configured durations supporting model retraining cycles. The method additionally comprises merging challenge feedback with downstream outcome signals including chargeback notifications from payment processors, account lockout events from fraud investigation teams, or successful transaction completions, creating enriched multi-signal labels that improve training data quality.

The method further comprises feedback step 132 comprising updating edge cache and policies, said step transmitting updated configurations from the ML Models component to the Edge PoP, wherein updated decision thresholds, policy rules, and risk score caches are propagated to edge enforcement nodes to reflect current threat landscape and business requirements.

The method additionally comprises a periodic model retraining process (not explicitly numbered in FIG. 1 sequence but shown in the feedback loop conceptually) comprising retraining detection models using accumulated labeled training data stored in step 132 to adapt to evolving attack patterns and improve detection accuracy. The retraining comprises loading training datasets from storage, applying data preprocessing including missing value imputation, outlier removal, and feature normalization. The retraining further comprises partitioning data into training and validation subsets using stratified sampling that maintains class distribution proportions, configuring machine learning algorithms with hyperparameter values, and executing training procedures that iteratively adjust model parameters to minimize prediction errors on training data. The retraining additionally comprises evaluating trained models on held-out validation data by computing performance metrics including accuracy, precision, recall, and area under receiver operating characteristic curves, comparing new model performance against incumbent production models, and selecting superior models for deployment.

The method additionally comprises a model deployment process (also part of the continuous improvement cycle shown in FIG. 1 feedback loops) comprising distributing updated models from the Analytics component to edge enforcement nodes. The distributing comprises detecting model version changes in model registries, constructing model distribution packages containing serialized model artifacts and version metadata, applying delta encoding or compression to reduce package sizes, and transmitting packages to edge nodes through content delivery networks or peer-to-peer distribution mechanisms. The method further comprises deploying updated models at edge nodes by downloading model packages, validating package integrity through checksum verification, loading new models into memory, switching traffic from old to new model versions using atomic operations that prevent request handling interruption, and monitoring error rates during gradual rollout phases to detect potential regression issues before full deployment.

It will be understood by persons of ordinary skill in the art that the embodiments described herein are illustrative and exemplary rather than exhaustive or limiting, and that numerous modifications, variations, substitutions, and equivalents will be apparent upon review of this disclosure without departing from the spirit and scope of the invention as defined by the appended claims.

The specific threshold values, timing parameters, and numerical ranges described herein, such as risk score thresholds of 0.85 to 0.95 for blocking decisions, rate limiting thresholds of 100 requests per minute, cache time-to-live values of 60 to 300 seconds, model inference latencies of 2 to 15 milliseconds, and sampling rates of 60 to 120 Hz, are provided as non-limiting illustrative examples of one particular implementation configuration. The invention is not limited to these specific values, and appropriate values will vary depending on application requirements, traffic volumes, user populations, threat landscapes, regulatory environments, hardware capabilities, and acceptable false positive rates. Persons skilled in the art will recognize that these parameters are design choices tunable through configuration without affecting the fundamental inventive concepts.

The specific technologies, platforms, and software implementations mentioned herein as examples, including but not limited to Apache Kafka, Amazon Kinesis, Apache Flink, Redis, Neo4j, Amazon Neptune, TensorFlow, PyTorch, ONNX Runtime, XGBoost, reCAPTCHA, MaxMind GeoIP2, NGINX, Envoy, MLflow, and similar commercial or open-source products, are cited solely to provide concrete illustrations of suitable implementations. The invention is not limited to any particular vendor, product, protocol, or technology and encompasses equivalent technologies providing similar functionality. Future technologies not yet in existence that provide equivalent capabilities are equally within the scope of the invention.

The machine learning model types described herein, including gradient boosted decision trees, random forests, neural networks, ensemble methods, isolation forests, one-class support vector machines, autoencoders, and LSTM networks, are provided as non-limiting examples of suitable approaches. The invention encompasses any statistical or computational method capable of generating risk scores or anomaly assessments from the described feature inputs, including future machine learning architectures not yet developed.

While the identity graph has been described with specific node types (user, device, session, credential, network identifier), specific edge types (used_by, associated_with, shares_account), and specific graph algorithms (Louvain modularity optimization, label propagation, PageRank), the invention is not limited to these specific graph schema or algorithmic implementations. Any graph data structure and associated algorithms capable of modeling entity relationships and detecting anomalous connectivity patterns fall within the scope of the invention.

The privacy-preserving transformations described herein, including SHA-256 hashing, principal component analysis, differential privacy mechanisms, tokenization, and homomorphic encryption, represent currently preferred implementations. The invention encompasses any irreversible transformation technique that prevents recovery of raw personally identifiable information from transmitted representations while preserving sufficient statistical information for risk assessment purposes, including future cryptographic or mathematical techniques providing equivalent privacy guarantees.

The description of components as separate modules, layers, engines, subsystems, or platforms does not imply any particular physical separation, deployment topology, or implementation boundary. Two or more described components may be combined into a single implementation, or a single described component may be distributed across multiple physical systems, without departing from the scope of the invention. Similarly, the described layered architecture does not require strict hierarchical separation; components from different layers may share infrastructure, communicate directly, or be co-located in the same computing environment.

The present invention is applicable to a wide range of deployment contexts beyond the specific examples described, including but not limited to: financial services and banking platforms, e-commerce and retail marketplaces, social media and content platforms, healthcare information systems, government digital services, telecommunications providers, gaming and entertainment platforms, cloud service providers, enterprise SaaS applications, and any other digital service requiring protection against automated abuse, fraudulent activity, or unauthorized access. The specific examples of malicious activity described herein represent non-limiting illustrations of the types of threats the system is designed to address, and the invention is not limited to detection of these specific attack types.

The claims appended hereto are intended to cover all such modifications and equivalent arrangements. The scope of the invention should be determined not with reference to the above description, but instead should be determined with reference to the claims along with their full scope of equivalents, it being understood that the intent is to claim all novel and non-obvious combinations and sub-combinations of the features described herein.

According to yet another embodiment, the present invention provides a non-transitory computer-readable storage medium having stored thereon executable instructions that, when executed by one or more processors, cause the processors to implement the distributed edge-native risk detection system. The executable instructions cause the processors to instantiate client-side instrumentation modules on user devices configured to observe user interaction events, generate behavioral feature data, transform the feature data using privacy-preserving techniques, and transmit transformed representations over secured channels. The executable instructions further cause the processors to instantiate edge enforcement nodes at network ingress locations configured to intercept application-layer requests, compute preliminary risk values using locally stored models, execute inline traffic control operations, and transmit telemetry to streaming layer. The executable instructions additionally cause the processors to instantiate streaming event processing resources configured to ingest telemetry from clients and edge nodes, normalize event formats, enrich events with network attributes, and provide ordered delivery to analytical services. The executable instructions further cause the processors to instantiate an identity graph engine configured to construct graph data structures with entity nodes and relationship edges, infer edges based on behavioral similarity and temporal correlation, update edge weights using time-decay functions, and detect anomalous multi-entity structures. The executable instructions additionally cause the processors to instantiate a risk intelligence platform 240 configured to compute risk scores from graph-derived features, generate enforcement directives, train detection models using labeled outcomes, and distribute updated models and policies to edge nodes. The computer-readable storage medium may comprise flash memory, solid-state drives, magnetic disks, optical media, or other non-volatile storage technologies. The executable instructions may be encoded in machine language, bytecode, or intermediate representations suitable for execution or just-in-time compilation. The processors may comprise general-purpose CPUs, graphics processing units, tensor processing units, field-programmable gate arrays, or application-specific integrated circuits.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims. The specification discloses exemplary embodiments that demonstrate different aspects of the invention. The invention is not limited to these exemplary embodiments. Many variations and modifications will be apparent to those of ordinary skill in the art upon review of this disclosure. The scope of the invention should be determined not with reference to the above description, but instead should be determined with reference to the claims along with their full scope of equivalents.

1. A computer-implemented system for detecting malicious or fraudulent digital activity in a distributed computing environment, the system comprising:
a client-side instrumentation module executable on a plurality of user devices, the client-side instrumentation module being configured to:
observe user interaction events comprising at least one of input timing patterns, gesture dynamics, navigation sequences, application state transitions, device integrity indicators, and execution environment attributes;
generate behavioral feature data by aggregating and temporally analyzing the observed user interaction events;
transform the behavioral feature data into privacy-preserving feature representations using at least one irreversible transformation technique selected from hashing, dimensional compression, tokenization, statistical noise injection, or cryptographic encoding;
suppress transmission of raw interaction data and personally identifiable information; and
transmit the privacy-preserving feature representations over a secured communication channel;
a plurality of edge enforcement nodes distributed across network ingress locations, each edge enforcement node comprising:
a request interception component configured to receive application-layer requests prior to routing to application services;
a real-time scoring engine configured to compute a preliminary risk value using locally stored detection models and policy data;
a policy execution component configured to selectively perform at least one inline traffic control operation selected from request blocking, connection throttling, protocol alteration, response modification, cryptographic challenge issuance, authentication escalation, or session termination; and
a telemetry generation component configured to transmit request metadata and enforcement outcomes;
a streaming layer comprising distributed processing resources configured to:
ingest telemetry originating from the client-side instrumentation module and the plurality of edge enforcement nodes;
normalize event formats into a unified schema;
enrich ingested telemetry with derived network attributes comprising at least one of geographic region, autonomous system identifier, protocol fingerprint, or session identifier; and
provide ordered event delivery to subscribing analytical services;
an identity graph engine configured to:
construct graph data structures comprising entity nodes representing users, devices, sessions, credentials, and network identifiers;
infer relational edges between entity nodes based on behavioral similarity, temporal correlation, and communication proximity;
dynamically update relationship weights using time-based decay functions; and
detect anomalous multi-entity structures indicative of coordinated malicious activity;
a risk intelligence platform configured to compute risk scores using features derived from the identity graph engine, wherein the risk intelligence platform comprising;
a policy generation engine configured to derive enforcement directives based on computed risk scores;
a model training subsystem configured to update detection models using labeled historical outcomes; and
a distribution interface configured to transmit updated policies and models to the plurality of edge enforcement nodes;
wherein the plurality of edge enforcement nodes execute enforcement actions independently of centralized traffic routing infrastructure.

2. The system of claim 1, wherein the irreversible transformation technique comprises applying cryptographic hash functions with one-way properties such that original behavioral data cannot be recovered from transmitted feature representations.

3. The system of claim 1, wherein the dimensional compression applies principal component analysis or autoencoder neural networks to reduce feature dimensionality while preserving discriminative information relevant to malicious activity detection.

4. The system of claim 1, wherein the real-time scoring engine accesses an edge cache containing synchronized copies of detection models and policy data, enabling autonomous decision-making without communication with centralized systems for each request.

5. The system of claim 1, wherein the policy execution component applies inline traffic control operations at OSI layer 7 to inspect and modify HTTP requests, HTTPS connections, WebSocket communications, or gRPC calls.

6. The system of claim 1, wherein the cryptographic challenge issuance comprises presenting CAPTCHA tests, proof-of-work puzzles, or cryptographic computation requirements to requesting clients.

7. The system of claim 1, wherein the streaming layer utilizes a distributed messaging system selected from Apache Kafka, Amazon Kinesis, or Google Cloud Pub/Sub to provide fault-tolerant, horizontally scalable event ingestion.

8. The system of claim 1, wherein the enrichment of ingested telemetry includes determining geographic region through IP geolocation databases and identifying autonomous system numbers through Border Gateway Protocol routing table lookups.

9. The system of claim 1, wherein the identity graph engine computes behavioral similarity using distance metrics applied to feature vectors, with entity nodes connected when similarity values exceed configurable threshold parameters.

10. The system of claim 1, wherein the time-based decay functions reduce relationship edge weights for connections not recently reinforced, allowing the identity graph to adapt to evolving attack patterns and preventing stale relationships from influencing current risk assessments.

11. The system of claim 1, wherein detection of anomalous multi-entity structures comprises identifying densely connected subgraphs representing bot networks, star patterns suggesting credential stuffing operations, or chain structures indicating account takeover progression.

12. The system of claim 1, wherein the real-time scoring engine computes graph-based features including node centrality metrics, edge density measures, community detection results, and path analysis between entities.

13. The system of claim 1, wherein the model training subsystem employs supervised learning techniques including gradient boosted decision trees, random forests, neural networks, or ensemble methods, with labels derived from fraud reports, chargebacks, account recovery requests, or user responses to cryptographic challenges.

14. The system of claim 1, wherein the distribution interface transmits updated policies and models through delta compression and incremental updates to minimize bandwidth consumption while maintaining synchronization across edge enforcement nodes.

15. The system of claim 1, further comprising an explainability framework configured to generate human-interpretable explanations for risk decisions using SHAP values, LIME, or attention mechanism analysis.

16. A computer-implemented method for detecting and preventing malicious digital activity, the method comprising:
collecting behavioral telemetry on a user device by observing user interaction patterns;
transforming said telemetry into privacy-preserving feature vectors on the user device through irreversible transformation functions;
transmitting the privacy-preserving feature vectors to an event streaming platform;
correlating the feature vectors with network-derived attributes received from distributed edge nodes;
constructing a continuously evolving identity graph linking devices, accounts, sessions, and network identifiers through relationship edges inferred from behavioral similarity and temporal correlation;
generating risk scores using the identity graph by computing graph-based features and combining said features with behavioral features through machine learning models;
distributing enforcement directives to edge nodes for real-time request handling; and
executing enforcement actions at edge nodes independently of centralized decision infrastructure by intercepting application-layer requests and applying inline traffic control operations based on locally computed risk values.

17. The method of claim 16, wherein the irreversible transformation functions include at least one of cryptographic hash functions, dimensional reduction algorithms, statistical noise injection, or tokenization schemes that prevent recovery of raw behavioral data.

18. The method of claim 16, wherein the identity graph relationship edge weights are updated using time-decay functions that reduce weights for relationships not recently reinforced, enabling adaptation to changing attack patterns.

19. A non-transitory computer-readable storage medium having stored thereon executable instructions that, when executed by one or more processors, cause the processors to:
instantiate client-side instrumentation modules configured to observe user interactions, generate behavioral features, transform features using privacy-preserving techniques, and transmit transformed representations;
instantiate edge enforcement nodes configured to intercept requests, compute risk values using locally stored models, execute traffic control operations, and transmit telemetry;
instantiate streaming event processing resources configured to ingest telemetry, normalize formats, enrich events, and deliver to analytical services;
instantiate an identity graph engine configured to construct graph structures, infer relationship edges, update edge weights, and detect anomalous patterns; and instantiate a risk intelligence platform configured to compute risk scores, generate enforcement directives, train models, and distribute updates to edge nodes.

20. The computer-readable storage medium of claim 19, wherein the executable instructions further cause the processors to execute enforcement actions at edge nodes independently of centralized infrastructure by performing local risk evaluation and inline traffic control without requiring per-request communication with central decision systems.
